(19) United States
(12) Patent Application Publication
(10) Pub. No.: US 2025/0162541 A1
(43) Pub. Date: May 22, 2025

(54) COLOR PREDICTIVE PERFORMANCE INDICATOR FOR WIPER BLADE ELEMENT

(71) Applicant: Trico Products Corporation, Cleveland, OH (US)

(72) Inventor: WILLIAM YOUNG, III, Vero Beach, FL (US)

(73) Assignee: Trico Products Corporation, Cleveland, OH (US)

(21) Appl. No.: 18/953,806

(22) Filed: Nov. 20, 2024

Related U.S. Application Data
(60) Provisional application No. 63/600,892, filed on Nov. 20, 2023.

(51) Int. Cl. B60S 1/38; G01D 7/00

(52) U.S. Cl. CPC B60S 1/38; G01D 7/005; B60S 2001/3827

(57) ABSTRACT

A predictive performance indicator based on the actual use and performance of any individual wiper blade element. This predictive performance indicator further provides visual feedback to the user that is independent of the user's location, UV exposure, climate and the like. The predictive performance indicator is adaptable and variable based solely on the actual use of the wiper blade element, and may be used to accurately provide feedback to the user regarding reduced performance and replacement of the blade element before performance degradation and/or failure of the blade element.

### CROSS REFERENCE TO RELATED APPLICATIONS

This application claims the benefit of U.S. Provisional Application Ser. No. 63/600,982 filed on Nov. 20, 2023; the disclosure of which is incorporated herein by reference.

### TECHNICAL FIELD

The present disclosure related generally to windshield wiper blades. More particularly, in one example, the present disclosure relates to a color predictive indicator for a windshield wiper blade element. Specifically, in another example, the present disclosure relates to a windshield wiper blade element coating that reduces at the point of contact between the wiper blade element and an associated windshield to indicate replacement and/or reduced performance of the wiper blade element.

### BACKGROUND ART

Windshield wipers are a common element of automobiles and other vehicles. The primary function of such wipers is to keep the windshield clear of moisture and similar objects that may obstruct or reduce visibility for the operator of the associated vehicle. Commonly, windshield wipers are moved across the surface of a vehicle windshield to physically move the liquid or obstruction out of the field of view for the operator.

Windshield wipers generally include a wiping element, or blade, that is formed of a flexible material to allow the blade to follow the contours of the windshield. The flexible nature of the blade further contacts the windshield in a manner that allows for a squeegee effect, wherein the interaction between the blade and the windshield draws water or other liquids across the windshield and out of the field of view.

Over time, the blade of the windshield wiper is prone to degradation and eventual failure due to numerous factors, UV exposure, frequency of use, cleanliness of the wiper blade and/or windshield, and the like. Thus, the expected lifespan of a windshield wiper blade is variable, largely dependent upon the location and climate in which the blade is used, as well as the personal habits of the vehicle operator. For example, a heavy user in a wet climate would tend to experience reduced performance sooner than a light user in a more moderate to dry climate. Extremely dry climates, such as desert climates, may also cause more a more rapid decline in performance of the wiper blade due to extreme sun and UV exposure as well as from over drying of the blade material.

Currently, the industry lacks a simple and reliable way to monitor performance and to indicate when reduced performance of a wiper blade warrants replacement. Current solutions most commonly include waiting until the performance is degraded to the point of blade failure, or to the point where the blade is no longer effective to keep the windshield clear. Reliance on these indicators can be dangerous as it is human nature to put off the replacement for as long as possible, which could lead to unsafe driving conditions due to reduced visibility and/or due to failure of the blade element during operation.

Other solutions have been introduced to utilize UV reactive stickers or UV reactive indicators that change color over time due to sun exposure. These UV reactive solutions are unreliable as they are not adaptable to different climates and are they likely to provide false indications in climates for which they were not originally calibrated. For example, most mass-produced UV indicators are calibrated based on an “average” environment, meaning one that is in the middle in temperature, precipitation, and UV exposure. Thus, blades deployed in high UV exposure would indicate replacement earlier than often necessary as the UV reactive indicator would degrade faster than the actual blade element, while blades in high precipitation climates with low UV exposure would experience reduced performance and/or failure before the UV reactive indicator recommends replacement. Adapting these UV indicators for various environments is likewise untenable as it would significantly increase the manufacturing burden and cost, while being difficult to deploy based on shifting weather and/or climate patterns. Further, some geographical locations would necessarily require multiple UV indicator versions due to changes in seasonal weather conditions.

### SUMMARY OF THE INVENTION

The present disclosure addresses these and other issues by providing a predictive performance indicator based on the actual use and performance of any individual wiper blade element. This predictive performance indicator further provides visual feedback to the user that is independent of the user's location, UV exposure, climate and the like. The predictive performance indicator is adaptable and variable based solely on the actual use of the wiper blade element, and may be used to accurately provide feedback to the user regarding reduced performance and replacement of the blade element before performance degradation and/or failure of the blade element.

In one aspect, an exemplary embodiment of the present disclosure may provide a windshield wiper blade element comprising: a body; a wiping element connected to the body, the wiping element including a core having a first color; and a coating applied to an outer surface of the core, the coating having a second color contrasting the first color.

In another aspect, an exemplary embodiment of the present disclosure may provide a method of monitoring wiper blade performance comprising: coating an outer surface of a wiper blade wiping element with a friction reducing and water repellant coating; wiping a windshield of a vehicle with the wiper blade; reducing the coating at the edges of the wiping element to form a shaped edge via the interaction between the edges of the wiping element and the vehicle windshield; revealing a core of the wiping element having a first color that contrasts a second color of the coating; and replacing the wiper blade when the first color of the core is revealed at the shaped edge of the wiping element.

### BRIEF DESCRIPTION OF THE DRAWINGS

Sample embodiments of the present disclosure are set forth in the following description, are shown in the drawings and are particularly and distinctly pointed out and set forth in the appended claims.

FIG. 1 (FIG. 1) is a partial side isometric perspective view of an exemplary blade element according to one aspect of the present disclosure.

FIG. 2 (FIG. 2) is an end elevation cross sectional view of an exemplary blade element taken in the direction of line 2-2 indicated in FIG. 1, according to one aspect of the present disclosure.

FIG. 3 (FIG. 3) is an enhanced view of a partial wiper blade element from the area indicated in FIG. 2 showing the predictive performance indicator at the beginning of its useable life, according to one aspect of the present disclosure.

FIG. 4 (FIG. 4) is an enhanced view of the partial wiper blade element from FIG. 3 showing the predictive performance indicator closer to the end of its usable life, according to one aspect of the present disclosure.

Similar numbers refer to similar parts throughout the drawings.

### DETAILED DESCRIPTION

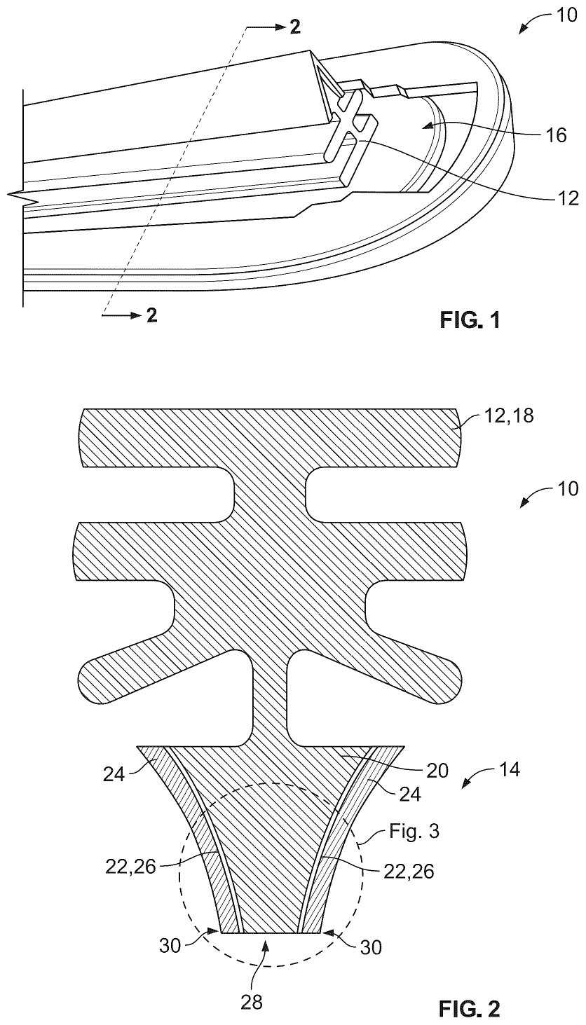

With reference to FIGS. 1 and 2, a wiper blade element of the present disclosure is shown and generally referenced at 10. The wiper blade element 10, or simply blade 10, may generally include a body 12 and a wiping element 14.

Body 12 may generally be the portion of the blade 10 that allows or otherwise facilitates the connection to a housing and/or frame 16, which may further allow the blade 10 to connect to an associated vehicle (not shown) for normal operation. Body 12 may include one or more mounting flanges or surfaces 18 which may connect to the frame 16. Mounting surfaces 18 may have any suitable configuration and/or shape to allow of use with multiple types of frames 16 or other similar blade 10 mounting arrangements.

Body 12 may be formed of any suitable materials and through any suitable means. According to one aspect, body 12 and wiping element 14 may be formed through extrusion, molding, or the like, and may be formed as a single connected element. According to another aspect, body 12 and wiping element 14 may be formed separately and affixed together through any suitable means, as dictated by the desired implementation thereof.

As mentioned above, body 12 may be formed of any suitable materials, including, but not limited to, silicone, natural or synthetic rubber or blends thereof, polymers, or other similar materials.

Wiping element 14 may be the portion of blade 10 that directly interacts with the windshield of an associated vehicle. According to one aspect, wiping element 14 may be integrally formed as part of a single unit with body 12. According to another aspect, wiping element 14 may be separately formed and attached thereto, according to the desired implementation.

Wiping element 14 may have a core substrate 20, referred to herein simply as core 20, which may be the portion of the wiping element 14 directly connected to the body 12. Core 20 may be formed of the same material as body 12, such as silicone or other suitable rubbers or polymers. Core 20 may have an outer surface 22 which may be better understood as the surface of wiping element 14 that directly interacts with the surface of the windshield.

Core 20 may further include a coating 24 applied to the outer surface 22 thereof. While coating 24 may be any suitable coating, it is contemplated that coating 24 may be a friction reducing and water repellant coating suitable to facilitate the normal operation of the blade element 10. According to another aspect, coating 24 may be hydrophobic or may further include hydrophobic qualities, as dictated by the desired implementation.

Coating 24 may be applied to outer surface 22 of core 20 through any suitable application method determined by the desired implementation of blade 10. According to one aspect, coating 24 may be a topical coating which may be applied as a surface level coating. According to another aspect, coating 24 may be chemically cross-linked to the core 20 to create a bonding layer 26 to further strengthen the bond between outer surface 22 of core 20 and the coating 24. Although shown in the figures with a cross-linked coating 24 and bonding layer 26, it will be understood that the predictive performance indicator of blade 10 (discussed further below) may be equally effective with topical coatings or any other suitable coatings, as provided herein.

The remaining features and benefits of blade element 10 may be best understood through a discussion of the operation and use thereof. Accordingly, the operation and use will now be discussed.

Functionally, blade 10 may operate similarly to existing windshield wiper blades in how the blade 10 is used to clear the windshield. Blade 10 may operate to wipe water and other objects away from the surface of the windshield through normal operation of a windshield wiper arm and motor. Blade 10 is contemplated to include frame 16 as well as any suitable mounting hardware to operably connect blade 10 to the vehicle.

Where blade 10 may differ from existing windshield wipers and wiper elements is the inclusion of a predictive performance indicator or performance indication system within blade 10. At its most basic, the predictive performance indicator may involve a first color layer, which may be the core 20, and a second color layer, which may be the coating 24.

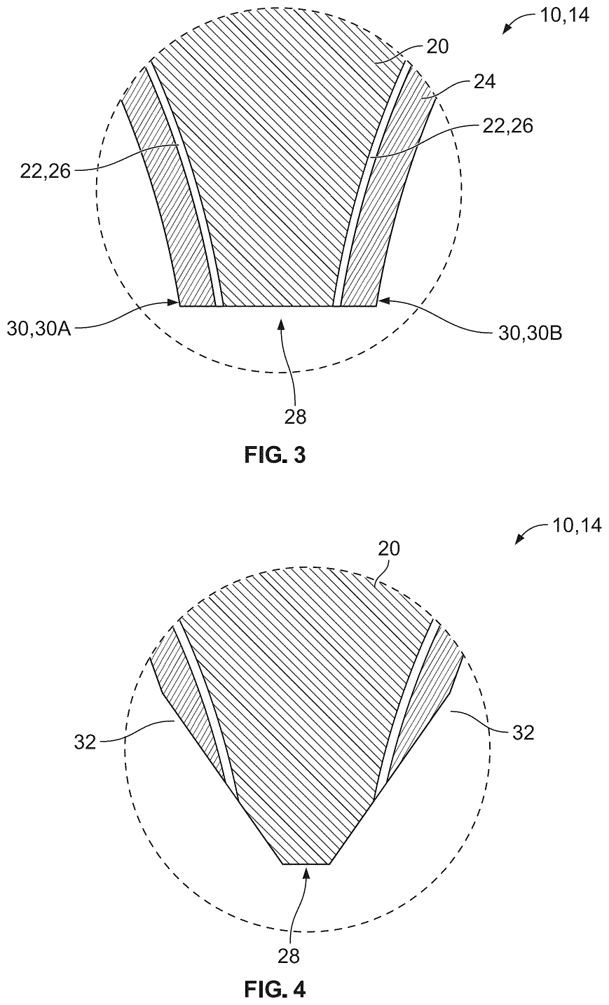

With reference to FIGS. 2 and 3, core 20 of wiping element 14 (and body 12 of blade 10, if desired) may be formed of a colored material, such as a colored silicone. Core 20 may be any suitable color, including primary colors, secondary colors, tertiary colors, or any suitable combination of colored material, including any chosen color from the visible spectrum. According to one non-limiting example, core 20 may be formed of blue silicone. The color of the core 20 (and body 12, as desired) may be considered a first color. It will be understood that the term first color is included merely to distinguish the color of core 20 from the color of the coating 24 in this disclosure, as discussed below.

Coating 24 may then have a second color that may be any suitable color provided that the second color visibly contrasts with the first color. As used herein, a contrast or contrasting color may be any suitable color that is visibly distinguishable from another color. Put another way, first color and second color may be contrasting in that first and second colors may be visibly distinguished.

According to the non-limiting example provided herein, where the first color is blue, the second color may be grey or black, or other similar color schemes (such as gunmetal or navy, etc.). Similarly, where the first color is any bright and highly visible color, the second color may again be grey or black, or the like. According to another aspect, the first and second colors could be reversed, with the second color being a bright and highly visible color and the first color being grey or black, or the like. Other suitable combinations may include colors at opposing ends of the spectrum, as well as custom color combinations to match vehicle paint and/or accessories, as desired. The color combinations between the first color of the core 20 and the second color of the coating 24 may be endless, with the only requirement being that the two colors chosen for the combination are contrasting enough to be easily discernable by the human eye.

With reference to FIGS. 2-4, in operation, the blade 10 may have a flat or truncated bottom surface 28 when the blade is newly installed and/or being first put into use. In normal operation of the blade 10, the edges 30 of the wiping element 14 will engage the windshield of the vehicle in alternating fashion. Specifically, a first edge 30A will engage the windshield as the blade 10 moves in a first direction, while a second edge 30B will engage the windshield as the blade 10 moves in the opposite direction. According to one example, the first direction may be the direction of movement when the wiper is first activated from a resting position and the second or opposite direction may be the direction returning the wiper to its normal resting position. Since each use of a normal wiper blade involves one pass over the windshield in each of these two directions, each edge 30A and 30B will engage the windshield once per pass of the blade 10.

This operation of the blade 10 will naturally cause some friction between the edges 30 of the wiping element 14 and the windshield. This in turn will cause the edges 30 to wear and erode. This is a natural part of the life of a wiper blade such as blade 10. With blade 10, as the edges 30 wear, they will begin to form a shaped region or shaped edge 32 on the edge 30, as best seen in FIG. 4. This shaped edge 32 may take on any suitable shape, such as a chamfered edge (as shown in FIG. 4) or a radial edge, or any other suitable shape profile. The specific profile of the shaped edge 32 may be determined by the interaction of the wiping element 14 with the windshield, as well as other variables such as the contour of the windshield, the strength, speed, and pressure of the wiper arm, and other similar factors.

The inclusion of coating 24 on wiping element 14 provides that the coating begins to wear earlier and faster than the core 20 of wiping element 14. The reduction of the coating 24 through use may further enhance the shaped edge 32 formed on the edges 30 of wiping element 14, in turn revealing the core 20 substrate. As the coating 24 continues to wear, more of the core 20 will be exposed. This will occur over time, however, the core 20 will be exposed before the performance of the blade 10 is reduced to a point of being unsafe or unusable.

The use of contrasting colors for the core 20 and coating 24 will allow the exposed core 20 to become visible to the operator's eye, thus predicting a forthcoming decline in wiper performance. The visible performance indicator may then indicate to the user that it is time to consider replacement of the blade 10 with a new part.

The thickness of coating 24 may have a direct effect on the visibility of the core 20 in that the thicker the coating is applied, the longer it will take to expose the core. While this initially sounds as though the performance may degrade before the predictive indicator is visible, the thickness of the coating is easily determined based on the expected lifespan of the wiping element. Similarly, there is no need for adjustment based on the climate and/or UV exposure as the predictive performance indicator is based on actual use and the physical cycles of the blade 10 engaging the windshield. Accordingly, in lower use climates, the blade 10 will have a longer lifespan and the indicator will be revealed more slowly than in high use environments.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain, using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

While components of the present disclosure are described herein in relation to each other, it is possible for one of the components disclosed herein to include inventive subject matter, if claimed alone or used alone. In keeping with the above example, if the disclosed embodiments teach the features of A and B, then there may be inventive subject matter in the combination of A and B, A alone, or B alone, unless otherwise stated herein.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

To the extent that the present disclosure has utilized the term “invention” in various titles or sections of this specification, this term was included as required by the formatting requirements of word document submissions pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

1. A windshield wiper blade element comprising:
a body;
a wiping element connected to the body, the wiping element including a core having a first color; and
a coating applied to an outer surface of the core, the coating having a second color contrasting the first color.

2. The wiper blade element of claim 1 wherein the first color comprises:
at least one of a primary color and a secondary color.

3. The wiper blade element of claim 1 wherein the second contrasting color comprises:
at least one of navy, grey, and black.

4. The wiper blade element of claim 1 where in the wiping element further comprises:
a first edge; and
a second edge, wherein the first and second edges contact a windshield of an associated vehicle when the wiper blade element is in use.

5. The wiper blade element of claim 4 wherein the first edge and second edge are operable to form a shaped edge during use.

6. The wiper blade element of claim 5 wherein the shaped edge further comprises:
a predictive performance indicator.

7. The wiper blade element of claim 6 wherein the predictive performance indicator further comprises:
a visible indicator showing the first color of the core when the blade is likely to provide a reduction in performance.

8. The wiper blade element of claim 1 wherein the coating further comprises:
At least one of a friction reducing and a water repellant coating.

9. A method of monitoring wiper blade performance comprising:
coating an outer surface of a wiper blade wiping element with a friction reducing and water repellant coating;
wiping a windshield of a vehicle with the wiper blade;
reducing the coating at the edges of the wiping element to form a shaped edge via the interaction between the edges of the wiping element and the vehicle windshield;
revealing a core of the wiping element having a first color that contrasts a second color of the coating; and
replacing the wiper blade when the first color of the core is revealed at the shaped edge of the wiping element.

10. The method of claim 9 wherein the first color comprises:
at least one of a primary color and a secondary color.

11. The method of claim 10 wherein the second contrasting color comprises:
at least one of dark grey and black.
